(19) United States
(12) Patent Application Publication
(10) Pub. No.: US 2023/0331348 A1
(43) Pub. Date: Oct. 19, 2023

(54) METHOD AND SYSTEM FOR EXHAUST GAS TREATMENT IN MARITIME VESSELS AND INSTALLATIONS

(71) Applicant: Hans Gude GUDESEN, Gamle Fredrikstad (NO)

(72) Inventor: Hans Gude GUDESEN, Gamle Fredrikstad (NO)

(21) Appl. No.: 18/027,089

(22) PCT Filed: Oct. 7, 2021
(86) PCT No.: PCT/NO2021/050205

§ 371 Date: Mar. 17, 2023

(30) Foreign Application Priority Data
Oct. 16, 2020 (NO) 20201123

(51) Int. Cl. B63B 1/38; F01N 3/04

(52) U.S. Cl. CPC B63B 1/38; F01N 3/04; B63B 2001/385; F01N 2590/02

(57) ABSTRACT

A method for exhaust gas treatment in vessels/installations located in a body of water is disclosed. The method comprises admixing ambient air to exhaust gas in a dilution unit (3) resulting in diluted exhaust gas, drawing water and diluted exhaust gas into bubble generator (4) and generating bubbles containing diluted exhaust gas in the water, and releasing the bubble-containing water into the body of water. A corresponding system is also disclosed.

### FIELD OF THE INVENTION

The present invention relates to a method and a system for treatment of exhaust gas from point emitters. More specifically it relates to reducing the environmental impact of the CO₂ and toxins carried by the exhaust gases from combustion engines on maritime vessels and installations.

### BACKGROUND OF THE INVENTION

Emission of harmful substances from point emitters of exhaust on maritime vessels and fixed or mobile installations constitute a major unsolved problem, both locally where concentrations of such substances may become high and on a global scale where the background concentration of CO₂ in the air is steadily rising and threatening the future of mankind. As of now, no viable solution of the problem is on the horizon. There is thus a pressing need to find remedies to remove the environmental load of exhaust emitters locally and globally.

### SUMMARY OF THE INVENTION

A first aspect of the invention is a method for exhaust gas treatment in vessels/installations located in a body of water, where the method comprises admixing ambient air to exhaust gas in a dilution unit resulting in diluted exhaust gas, drawing water and diluted exhaust gas into a bubble generator and generating bubbles containing diluted exhaust gas in the water, and releasing the bubble-containing water into the body of water.

Optionally, the step of generating bubbles comprises generating nano- or microbubbles.

Optionally, the method further comprises, before the admixing of ambient air, scrubbing of the exhaust gas to remove specific harmful substances.

Optionally, the method comprises extracting energy from the exhaust gas by converting thermal energy to mechanical energy, where the mechanical energy optionally comprises energy in the form of at least one of high pressure steam and electricity.

The admixture ratio of the admixing preferably is in the range 2-300 to 1 of ambient air to exhaust gas, and even more preferably in the range 100-300 to 1.

Optionally, the vessel/installation is a vessel with a hull, and the releasing comprises distributing the bubble-containing water in a curtain-like fashion cloaking parts of the hull of the vessel.

Optionally, the method comprises transporting the diluted exhaust gas from the dilution unit via a transport tube to the bubble generator being remotely arranged relative to the installation/dilution unit.

Optionally, the releasing comprises transporting the bubble containing water via a transport tube, and remotely to the vessel/installation injecting it into the body of water.

A further aspect of the invention is system for treating exhaust gas from a point emitter/combustion engine in vessels/installations located in a body of water, where the system comprises a dilution unit arranged for admixing ambient air to the exhaust gas resulting in diluted exhaust gas, a bubble generator arranged for receiving water and the diluted exhaust gas and generating bubbles containing diluted exhaust gas in the water; and means for releasing the bubble-containing water into the body of water.

Optionally, the bubbles comprise nano- or microbubbles.

Optionally, the system further comprises means for scrubbing the exhaust gas to remove specific harmful substances prior to the admixing.

Optionally, the system comprises means for extracting energy from the exhaust gas by converting thermal energy to mechanical energy, where the mechanical energy optionally comprises energy in the form of at least one of high pressure steam and electricity.

Optionally, the dilution unit is arranged for admixing with an admixture ratio preferably in the range 2-300 to 1 of ambient air to exhaust gas, and even more preferably in the range 100-300 to 1.

Optionally, when the vessel/installation is a vessel with a hull, the means for releasing are arranged for distributing the bubble-containing water in a curtain-like fashion cloaking parts of the hull of the vessel.

Optionally, the system comprises means, e.g. a transport tube, arranged for transporting the diluted exhaust gas from the dilution unit to the bubble generator, the bubble generator being remotely arranged relative to the installation/dilution unit, where further optionally, the means for releasing comprises an injector unit, and the bubble generator and the injector unit are arranged at the transport tube in a in fluidal series connection.

Optionally, the bubble generator is of venturi type with a throat region at least partly perforated by a plurality of holes where water from the body of water can mix with the diluted exhaust gas, and the mixture passes through a cavitation mesh arranged for breaking up bubbles to nano- or micro-size before being released into the body of water, where optionally the cavitation mesh comprises nanofibrillated cellulose optionally derived from tunicates.

Optionally, the vessel/installation is a fixed or mobile drilling or processing installation.

### DESCRIPTION OF THE DIAGRAMS

The above and further features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following diagrams wherein:

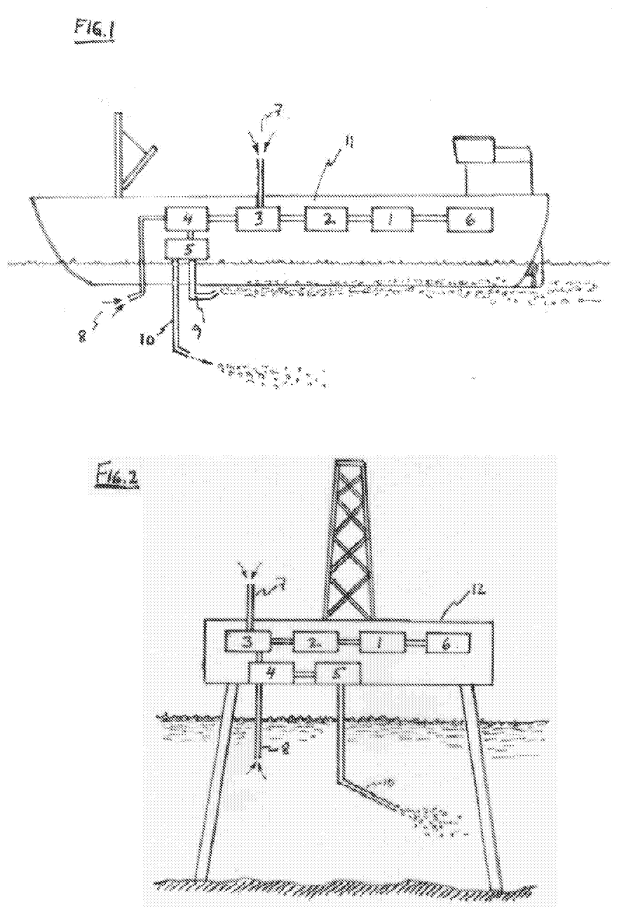

FIG. 1 shows an embodiment where exhaust gas from a seagoing vessel is scrubbed, diluted with air, admixed with water and released as nanobubbles into the sea.

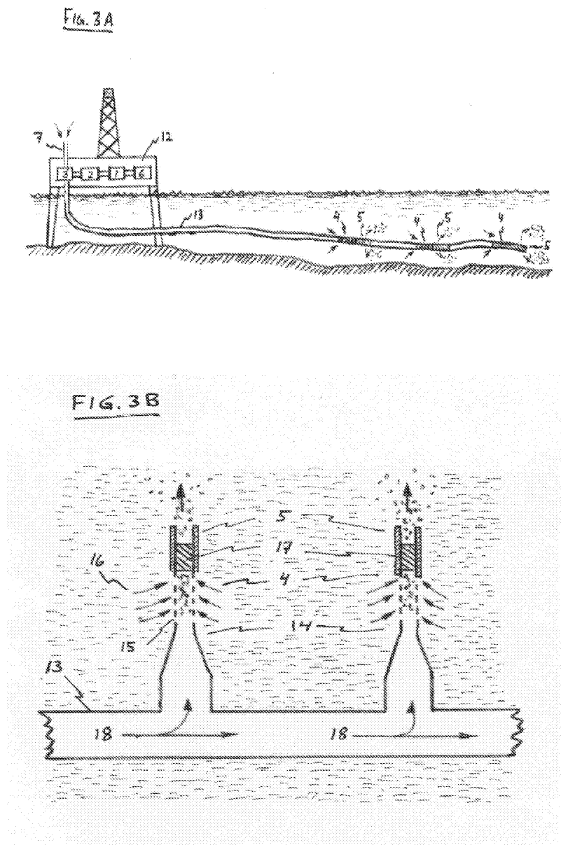

FIG. 2 shows an embodiment where exhaust gas from a maritime installation is scrubbed, diluted with air, admixed with water and released as nanobubbles into the sea.

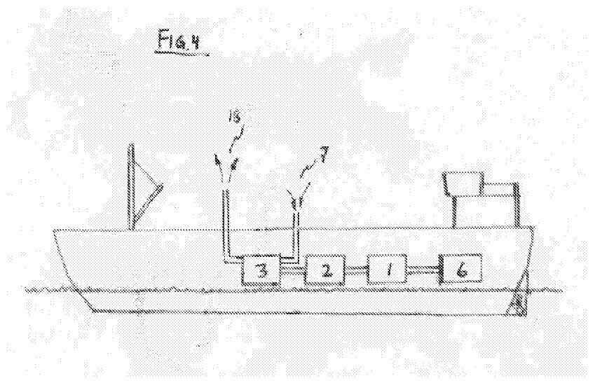

FIG. 3A shows an embodiment where exhaust gas from a maritime installation is scrubbed, diluted with air and transported to a water volume a distance away from the installation where it is admixed with water and released as nanobubbles into the sea.

FIG. 3B shows an example where bubble generators (4) and injector units (5) are arranged at different locations along a transport tube (13)

FIG. 4 shows an embodiment where exhaust gas from a seagoing vessel is scrubbed and diluted with air before being released to the atmosphere.

List of reference number in the figures

The following reference numbers refer to the drawings:

### NUMBER DESIGNATION

1 Scrubber
2 Energy extractor
3 Dilution unit
4 Bubble generator
5 Injector unit
6 Engine
7 Air intake
8 Intake port
9 Distributor pipe
10 Injector pipe
11 Vessel
12 Maritime installation
13 Transport tube
14 Throat region
15 Holes
16 Water from the outside
17 Cavitation mesh
18 Diluted exhaust gas
19 Spreader chimney

Description of preferred embodiments of the invention.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

One major strategy of the present invention is to render exhaust gas from maritime vessels and installations harmless to the environment by diluting it with ambient air to a level where the CO₂ concentration is low, to mix the diluted gas mixture with sea water to form bubbles and to inject the bubble-laden water into the sea. When employing bubbles with a large fraction of bubble diameters in the nanometer to micrometer domain, the gas can be sequestered for long time periods in the water, allowing physical, biological and chemical processes to consume the CO₂ or convert it to harmless substances (e.g. carbonates and bicarbonates).

Another major strategy of the present invention is to release and distribute bubble-laden water under a seagoing vessel in such a manner that a bubble curtain is formed cloaking the hull and reducing the friction of the vessel as it passes through the water.

In a first class of preferred embodiments according to the present invention, exemplified in FIG. 1, the exhaust gas derives from point emitters, e.g. a turbine or other type of combustion engine (6) providing propulsion and on-board power for a seagoing vessel (11). The exhaust gas passes through a series of stages as follows:
Stage 1): Specific harmful substances in the exhaust gas from the engine (6) are removed in a scrubber (1). This stage is optional, depending on the type and concentration of the harmful substances that are present in the case in question.
Stage 2): A thermal energy converter (2) extracts energy from the exhaust gas and delivers mechanical energy in the form of high pressure steam, and/or in the form of electricity. Equipment and processes for energy extraction from hot exhaust gases are well known in the art.
Stage 3): The exhaust gas is diluted by admixing plain air drawn in from the outside via an air intake (7) in a dilution unit (3). The mixing ratio between exhaust gas and ambient air may be selected within a wide range. In one scenario, an admixture of 250 parts ambient air and one part exhaust gas shall cause the CO₂ concentration in the mixture to approach very closely that prevailing in ambient air (400 p.p.m.).
Stage 4): Bubbles are generated in the bubble generator (4) where seawater drawn via the intake port (8) is processed together with diluted exhaust gas from dilution unit (3). In this preferred embodiment, the bubbles have diameters in the nanometer domain and shall subsequently be referred to as nanobubbles. As is known in the art, nanobubbles exhibit a range of potentially useful properties, such as neutral buoyancy, long term survivability in water, and high interactivity in biological and chemical processes. In cases where the degree of ambient air admixture is high, the nanobubbles shall contain oxygen which may have beneficial effects on sea life suffering from anoxia, and thus reverse euthrophication. In the present context, neutral buoyancy of the nanobubbles cause them to remain in the water and follow water currents instead of floating to the top, increasing interaction times with the water and species therein, and simplifying sequestration of bubbles in the water volume. Important processes of particular interest here are the dissolution of CO₂ in seawater and subsequent conversion to carbonates and bicarbonates, as well as direct uptake of gas from nanobubbles in phytoplankton and sea-dwelling organisms.
Stage 5): The bubble-containing water is released to the sea via an injector unit (5) and injector pipe (10), and/or:
Stage 6): A distributor pipe or manifold (9) provides a bubble curtain cloaking the hull of the vessel. It is well known in the art that air bubbles can reduce the resistance between the hull of a ship and the surrounding water, cf. e.g.: M. Kawabuchi et al.: “CFD Predictions of Bubbly Flow around an Energy-saving Ship with Mitsubishi Air Lubrication System”, Mitsubishi Heavy Industries Technical Review Vol. 48, No. 1 (March 2011). Cf. also R. Kantharia: “How Air Lubrication Systems for Ships Works?”, http://www.mhi.co.ip/technology/reniew/pdf/e481/e481053.pdf. This approach solves certain problems that adhere to such air lubrication systems: They require a bespoke hull design and gas handling infrastructure, and shall need copious amounts of air under pressure. Also, lack of control of the bubble sizes can lead to excessive loss of bubbles and cavitation damage to the propellers.

According to the present invention, high levels of air dilution shall be the norm in the exhaust gas treatment, providing large volumes of air as a byproduct that can be used for bubbling. In one scenario, the bubbles created in Stage 6) may range across a wide size distribution, as appears to be the case in the examples of air lubrication referred above. However, the controlled preparation of water laden with nano- and microbubbles prior to release in the ocean opens up for simultaneously serving the goals of air lubrication and gas sequestration in the ocean.

In another class of preferred embodiments according to the present invention, exemplified in FIG. 2, the exhaust gas derives from a turbine or other type of combustion engine (6) providing power on a maritime installation (12), e.g. a fixed or mobile drilling platform. The exhaust gas passes through a series of stages as follows:
Stage 1): Specific harmful substances in the exhaust gas from the engine (6) are removed in a scrubber (1). This stage is optional, depending on the type and concentration of the harmful substances that are present in the case in question.
Stage 2): A thermal energy converter (2) extracts energy from the exhaust gas and delivers mechanical energy in the form of high pressure steam, and/or in the form of electricity. Equipment and processes for energy extraction from hot exhaust gases are well known in the art.
Stage 3): The exhaust gas is diluted by admixing plain air drawn in from the outside via an air intake (7) in a dilution unit (3). The mixing ratio between exhaust gas and ambient air may be selected within a wide range. In one scenario, an admixture of 250 parts ambient air and one part exhaust gas shall cause the CO₂ concentration in the mixture to approach very closely that prevailing in ambient natural air (400 p.p.m.).
Stage 4): Bubbles are generated in the bubble generator (4) where seawater drawn via the intake port (8) is processed together with diluted exhaust gas from dilution unit (3). In this preferred embodiment, the bubbles shall preferably have diameters in the nanometer domain and shall subsequently be referred to as nanobubbles. As is known in the art, nanobubbles exhibit a range of potentially useful properties, such as neutral buoyancy, long term survivability in water, and high interactivity in biological and chemical processes. In cases where the degree of ambient air admixture is high, the nanobubbles shall contain oxygen which may have beneficial effects on sea life suffering from anoxia, and reverse euthrophication. In the present context, neutral buoyancy of the nanobubbles cause them to remain in the water and follow water currents instead of floating to the top, increasing interaction times with the water and species therein, and simplifying sequestration of bubbles in the water volume. Important processes of particular interest here are the dissolution of CO₂ in seawater and subsequent conversion to carbonates and bicarbonates, as well as direct uptake of gas from nanobubbles in phytoplankton and sea-dwelling organisms.
Stage 5): The bubble-containing water is released to the sea via an injector unit (5) and injector pipe (10).

In yet another class of preferred embodiments according to the present invention, exemplified in FIG. 3A, the exhaust gas derives from a turbine or other type of combustion engine (6) providing power on a maritime installation (12), e.g. a fixed or mobile drilling platform. In this case, the diluted exhaust gas from the dilution unit (3) is transported in a transport tube (13) that extends from the installation (12) to a water volume at some distance away where the bubble generator units (4) and injector units (5) are located, spreading bubbles into the water volume. These units may be integrated into the transport tube at multiple locations as exemplified in

FIG. 3A..

In analogy with the previously mentioned preferred embodiments, the exhaust gas passes through a series of stages as follows:
Stage 1): Specific harmful substances in the exhaust gas from the engine (6) are removed in a scrubber (1). This stage is optional, depending on the type and concentration of the harmful substances that are present in the case in question.
Stage 2): A thermal energy converter (2) extracts energy from the exhaust gas and delivers mechanical energy in the form of high pressure steam, and/or in the form of electricity. Equipment and processes for energy extraction from hot exhaust gases are well known in the art.
Stage 3): The exhaust gas is diluted by admixing plain air drawn in from the outside via an air intake (7) in a dilution unit (3). The mixing ratio between exhaust gas and ambient air may be selected within a wide range. In one scenario, an admixture of 250 parts ambient air and one part exhaust gas shall cause the CO₂ concentration in the mixture to approach very closely that prevailing in ambient natural air (400 p.p.m.).
Stage 4): The diluted exhaust gas is fed to a transport tube (13) which may extend a significant distance from the installation (12) to reach locations where gas bubbles can be released to the seawater. One or more bubble generators (4) and injector units (5) may be linked to the transport tube (13) and may be integrated into the latter as indicated in FIG. 3A. In this case, seawater may be drawn in directly to the bubble generator (4) from the surrounding water volume. In this preferred embodiment, the bubbles have diameters in the nanometer domain and shall subsequently be referred to as nanobubbles. As is known in the art, nanobubbles exhibit a range of potentially useful properties, such as neutral buoyancy, long term survivability in water, and high interactivity in biological and chemical processes. In cases where the degree of ambient air admixture is high, the nanobubbles shall contain oxygen which may have beneficial effects on sea life suffering from anoxia, and reverse euthrophication. In the present context, neutral buoyancy of the nanobubbles cause them to remain in the water and follow water currents instead of floating to the top, increasing interaction times with the water and species therein, and simplifying sequestration of bubbles in the water volume. Important processes of particular interest here are the dissolution of CO₂ in seawater and subsequent conversion to carbonates and bicarbonates, as well as direct uptake of gas from nanobubbles in phytoplankton and sea-dwelling organisms.
Stage 5): The bubble-containing water is released to the sea via an injector unit (5) which shall typically be directly linked to the bubble generator (4).

FIG. 3B shows an example where bubble generators (4) and injector units (5) are arranged at different locations along a transport tube (13) in analogy to the case shown in FIG. 3A. In this preferred embodiment, the bubble generators are of the venturi type, where diluted exhaust gas (18) in the transport tube (13) is diverted into side vents that narrow into a throat region (14) where the gas speed is higher and the pressure is lower. The walls in the throat region are perforated by a plurality of small holes (15) where water from the outside (16) can enter and mix with the gas inside. The gas and water mixture passes through a cavitation mesh (17) where bubbles are broken up to nanosize before being ejected into the water volume by the injector units (5). The cavitation mesh (17) may contain nanofibrillated cellulose, preferably derived from tunicates.

FIG. 4. shows a system where stages 4 and 5 are omitted and the cleaned and diluted exhaust gas is returned to the atmosphere via a spreader chimney (18).

1. A method for exhaust gas treatment in vessels/installations located in a body of water, where the method comprises the following steps:
admixing ambient air to exhaust gas in a dilution unit (3) resulting in diluted exhaust gas;
drawing water and diluted exhaust gas into a bubble generator (4) and generating bubbles containing diluted exhaust gas in the water; and
releasing the bubble-containing water into the body of water.

2. The method according to claim 1, where the step of generating bubbles comprises generating nano- or microbubbles.

3. The method according to claim 1, further comprising, before the admixing of ambient air, scrubbing of the exhaust gas to remove specific harmful substances.

4. The method according to claim 1, comprising extracting energy from the exhaust gas by converting thermal energy to mechanical energy.

5. The method according to claim 4, where the mechanical energy comprises energy in the form of at least one of high pressure steam and electricity.

6. The method according to claim 1, where the admixture ratio preferably is in the range 2-300 to 1 of ambient air to exhaust gas, and even more preferably in the range 100-300 to 1.

7. The method according to claim 1, where the vessel/installation is a vessel with a hull, and the releasing comprises distributing the bubble-containing water in a curtain-like fashion cloaking parts of the hull of the vessel.

8. The method according to claim 1, further comprising transporting the diluted exhaust gas from the dilution unit (3) via a transport tube to the bubble generator (4) being remotely arranged relative to the installation/dilution unit.

9. The method according to claim 1, where the releasing comprises transporting the bubble containing water via a transport tube, and remotely to the vessel/installation injecting it into the body of water.

10. A system for treating exhaust gas from a point emitter/combustion engine in vessels/installations located in a body of water, where the system comprises:
a dilution unit (3) arranged for admixing ambient air to the exhaust gas resulting in diluted exhaust gas;
a bubble generator (4) arranged for receiving water and the diluted exhaust gas and generating bubbles containing diluted exhaust gas in the water; and
means for releasing the bubble-containing water into the body of water.

11. The system according to claim 10, where the bubbles comprise nano- or microbubbles.

12. The system according to claim 10, further comprising, means for scrubbing the exhaust gas to remove specific harmful substances prior to the admixing.

13. The system according to claim 10, comprising means for extracting energy from the exhaust gas by converting thermal energy to mechanical energy.

14. The system according to claim 13, where the mechanical energy comprises energy in the form of at least one of high pressure steam and electricity.

15. The system according to claim 10, where the dilution unit (3) is arranged for admixing with an admixture ratio preferably in the range 2-300 to 1 of ambient air to exhaust gas, and even more preferably in the range 100-300 to 1.

16. The system according to claim 10, where the vessel/installation is a vessel with a hull, and the means for releasing are arranged for distributing the bubble-containing water in a curtain-like fashion cloaking parts of the hull of the vessel.

17. The system according to claim 10, where the system comprises means, e.g., a transport tube, arranged for transporting the diluted exhaust gas from the dilution unit (3) to the bubble generator (4), the bubble generator (4) being remotely arranged relative to the installation/dilution unit.

18. The system according to claim 17, where the means for releasing comprises an injector unit, and the bubble generator and the injector unit are arranged at the transport tube in a in fluidal series connection.

19. The system according to claim 18, where the bubble generator (4) is of venturi type with a throat region (14) at least partly perforated by a plurality of holes (15) where water from the body of water can mix with the diluted exhaust gas, and the mixture passes through a cavitation mesh (17) arranged for breaking up bubbles to nano- or micro-size before being released into the body of water.

20. The system according to claim 19, where the cavitation mesh (17) comprises nanofibrillated cellulose optionally derived from tunicates.

21. The system according to claim 10, where the vessel/installation is a fixed or mobile drilling or processing installation.
